(19) United States
(12) Patent Application Publication
(10) Pub. No.: US 2008/0057202 A1
(43) Pub. Date: Mar. 6, 2008

(54) METHOD OF FABRICATING METAL LINE BY WET PROCESS

(75) Inventors: CHIEN-WEI WU, HSNCHU COUNTY (TW); SHUO-WEI LIANG, TAIPEI COUNTY (TW); WAN-CHI CHEN, TAIPEI COUNTY (TW); CHENG-TZU YANG, HSINCHU COUNTY (TW); SAI-CHANG LIU, KAOHSIUNG COUNTY (TW); PO-CHIU CHEN, HSINCHU CITY (TW); MIN-CHUAN WANG, CHIAYI CITY (TW); YUNG-CHIA KUAN, TAIPEI CITY (TW)

Correspondence Address: J C PATENTS, INC., 4 VENTURE, SUITE 250, IRVINE, CA, 92618, US

(73) Assignees: TAIWAN TFT LCD ASSOCIATION, HSINCHU (TW); CHUNGHWA PICTURE TUBES, LTD., TAIPEI (TW); AU OPTRONICS CORPORATION, HSINCHU (TW); HANNSTAR DISPLAY CORPORATION, TAO-YUAN HSIEN (TW); CHI MEI OPTOELECTRONICS CORPORATION, TAINAN COUNTY (TW); INDUSTRIAL TECHNOLOGY RESEARCH INSTITUTE, HSINCHU (TW); TPO DISPLAYS CORP., MIAO-LI COUNTY (TW)

(21) Appl. No.: 11/562,064

(22) Filed: Nov. 21, 2006

(30) Foreign Application Priority Data
Aug. 31, 2006 (TW) 95132216

(51) Int. Cl. B05D 5/12; B05D 3/04; B05D 1/36

(52) U.S. Cl. 427/304; 427/305; 427/404; 427/58

(57) ABSTRACT

A method of fabricating of a metal line by a wet process is provided. A catalytic adhesive layer is formed on an insulating substrate. A fist metal layer is formed by an electoless plating process, and then, a second metal layer is formed by an electoless plating process or an electoplating process. The first and the second metal layers are patterned to form a metal line.

### CROSS-REFERENCE TO RELATED APPLICATION

This application claims the priority benefit of Taiwan application serial no. 95132216, filed Aug. 31, 2006. All disclosure of the Taiwan application is incorporated herein by reference.

### BACKGROUND OF THE INVENTION

1. Field of the Invention

The present invention generally relates to a method of fabricating a metal line, and more particularly to a method of fabricating a metal line by a wet process.

2. Description of Related Art

As the glass substrate size gets larger and larger, the vacuum apparatus for sputtering thin films is larger and more expensive. If the wet process is used, the expensive vacuum apparatus is not needed. In addition, the process time is reduced and the process throughput is increased because the substrate is not needed to get in and out the vacuum chamber.

The wet depositing method includes an electoplating process and an electoless plating process. The conventional electoless planting process is immersing a deposited matter in a catalyst, and then the deposited matter is immersed in a planting bath to deposit a metal film. Because the catalyst adheres on the front surface and back surface of the substrate, the film would be deposited on the two surfaces of the substrate. Usually, the deposited film on one of the surfaces of the substrate should be removed before processes, and therefore the process step is more complex and the catalyst is consumed. Furthermore, the catalyst tank and the planting tank (also occupy a lot of space.

Currently, many electoless planting methods are provided, such as U.S. Pat. No. 6,413,845 and U.S. Pat. No. 6,897,135.

FIGS. 1A-1D are cross-sectional views showing a method of forming a conductive line disclosed in U.S. Pat. No. 6,413,845. Referring to FIG. 1A, an electoless planting Ni layer 12 is deposited on a glass substrate 10, and then a photo resist layer 14 is formed and an Au layer 16 is deposited. Next, as shown in FIG. 1B, the photo resist layer 14 is removed. Referring to FIG. 1C, the Ni layer 12 is etched by using the Au layer 16 as an etching mask. Thereafter, as shown in FIG. 1D, a Cu line 18 is selectively deposited by electoless planting or electoplating.

FIGS. 2A-2D are cross-sectional views showing a method of forming an electoless planting metal film disclosed in U.S. Pat. No. 6,897,135. The method includes cracking a photo sensitive catalyst precursor to form a Pd layer. Referring to FIG. 2A, the catalyst precursor 22 has a form of compound, ion or gel. Next, as shown in FIG. 2B, the catalyst precursor is solved in an organic solvent, and then it is coated on the surface of the glass substrate 20 to form a coating layer 24. Referring to FIG. 2C, the catalyst Pd 26 is remained on the glass substrate 20 after the catalyst precursor is irradiated and cracked, and the un-irradiated portion is removed with an organic solvent to form Pd patterns. After that, as shown in FIG. 2D, a Ni film 28 and a Cu film 29 are formed on the catalyst Pd 26.

Since the adhesion between the film and the glass substrate is poor by using the conventional electoless planting methods, the surface of the glass substrate is usually needed to be micro-roughed to increase the adhesion between the film and the glass substrate. However, this method would increase the film roughness and the process step is more complex.

### SUMMARY OF THE INVENTION

The present invention is directed to a method of fabricating a metal line capable of depositing a metal film on a single surface of the substrate by a wet planting method.

The present invention is also directed to a method of fabricating a metal line capable of forming a metal film with a wet planting method, wherein the adhesion between the film and the glass substrate is increased without micro-roughing the glass substrate.

A method of fabricating of a metal line by a wet process is provided. A catalytic adhesive layer is formed on an insulating substrate. A fist metal layer is formed by an electoless plating process, and then, a second metal layer is formed by an electoless plating process or an electoplating process. In addition, the method further comprises patterning at least one of the second metal layer, the first metal layer and the catalytic adhesive layer.

The method of forming the metal line of the present invention can use the electoless planting to deposit the metal film on a single surface of the substrate.

The method of forming a metal line of the present invention uses the electoless planting to form the metal film, wherein the adhesion between the film and the glass substrate is increased without micro-roughing the glass substrate.

### BRIEF DESCRIPTION OF THE DRAWINGS

FIGS. 1A-1D are cross-sectional views showing a method of forming a conductive line in the prior art.

FIGS. 2A-2D are cross-sectional views showing a conventional method of forming an electoless planting metal film.

FIGS. 3A-3D are cross-sectional views showing a method of forming a metal line according to an embodiment of the present invention.

FIGS. 4A-4C are cross-sectional views showing a method of forming a metal line according to another embodiment of the present invention.

FIGS. 5A-5C are cross-sectional views showing a method of forming a metal line according to, another embodiment of the present invention.

FIGS. 6A-6E are cross-sectional views illustrating the steps of fabricating a thin film transistor according to an embodiment of the present invention.

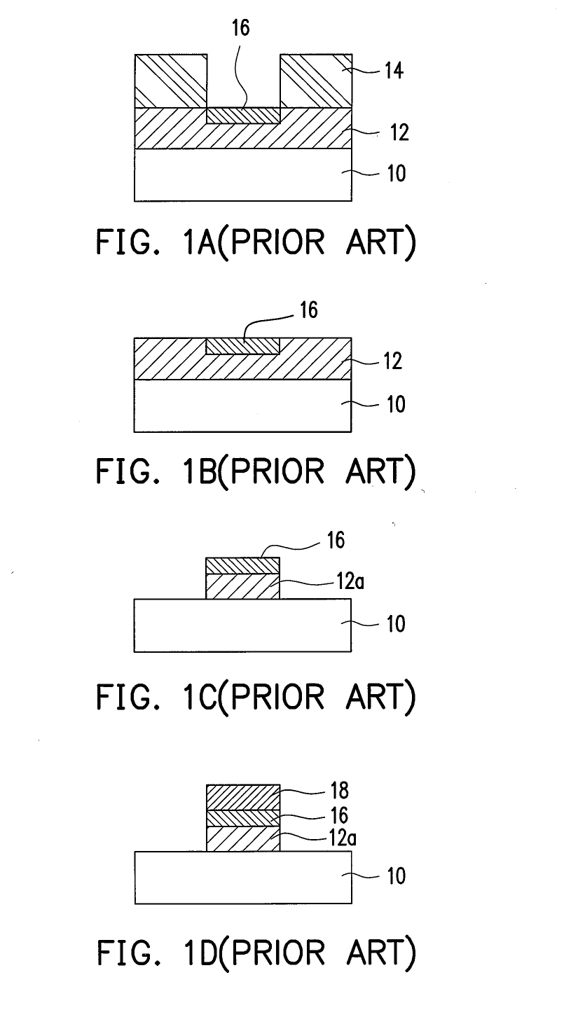

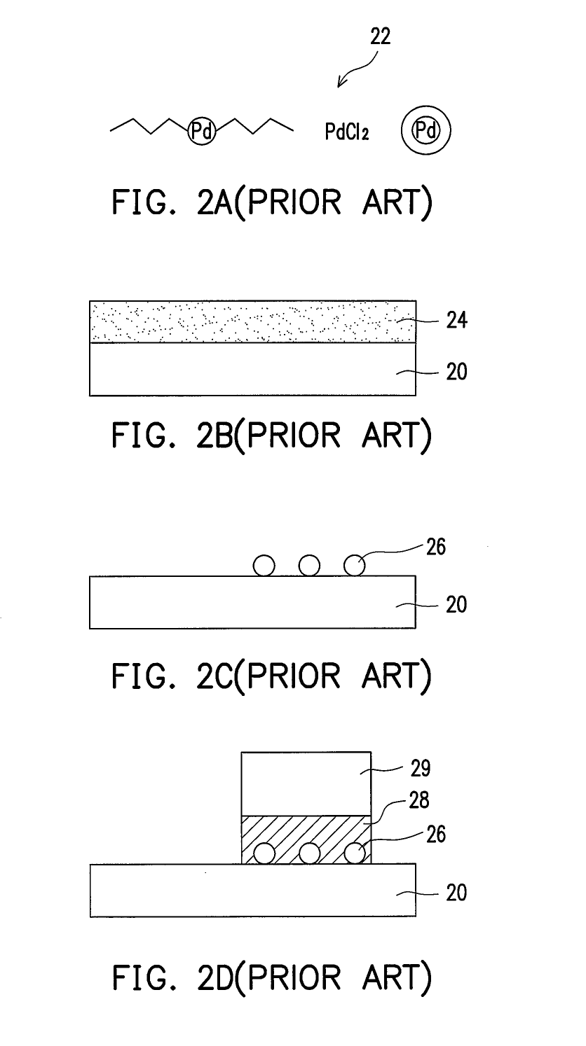

### DESCRIPTION OF EMBODIMENTS

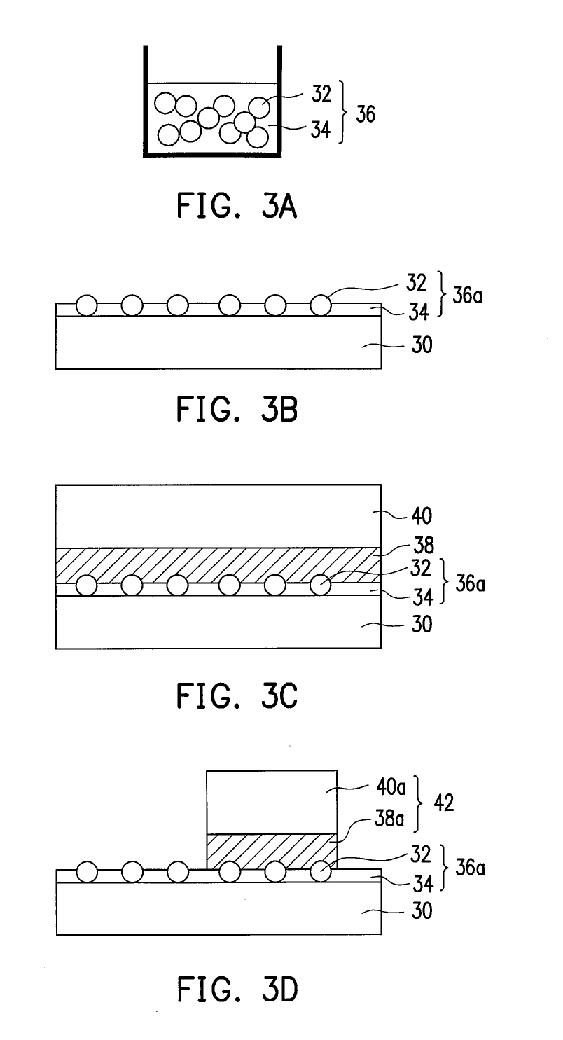

FIGS. 3A-3D are cross-sectional views showing a method of forming a metal line according to an embodiment of the present invention.

Referring to FIG. 3A, a mixture 36 is prepared, wherein the mixture 36 includes an electoless planting catalyst 32, an organic polymer 34 and a suitable organic solvent. The electoless planting catalyst 32 comprises palladium (Pd), stannum (Sn) or a mixture thereof, and the electoless planting catalyst 32 has an amount of 0.1-5% based on the total weight of the mixture 36. The organic polymer 34 comprises acrylic-copolymer, polyimide, benzocyclobutene or polyarylene ether. Preferably, the organic polymer 34 is acrylic-copolymer or polyimide. The organic solvent depends on the type of the organic polymer 34, and it can be N-Methyl-2-Pyrrolidone (NMP). The inorganic material, such as hydrogen silesquioxane (HSQ) or methylsilsesquioxane (MSQ), can be used in the process.

Next, as shown in FIG. 3B, the mixture 36 is coated onto the insulating substrate 30, and then a high temperature thermal process is carried out to remove the organic solvent so as to form a catalytic adhesive layer 36a, wherein the catalytic adhesive layer 36a includes the catalyst 32 and the organic polymer 34 which used as a adhesive. The insulating substrate 30, for example, is a plastic or glass substrate. The coating method can be -spin coating, slit coating or printing, for example. The temperature and time of the high temperature thermal process depends on the type of the organic solvent and the polymer 34. The temperature is, for example, in a range of 150˜500° C., and the process time is, for example, in a range of 10˜120 minutes. If the polymer 34 is acrylic-copolymer-and the organic solvent is NMP, the temperature of the high temperature thermal process is, for example 450° C. and the process time is, for example, from 30 to 60 minutes.

Then, as shown in FIG. 3C, a metal layer 38 is formed on the catalytic adhesive layer 36a. The material of the metal layer 38 is, for example, Cu, Ni, Co, W, Ag or an alloy thereof, and the metal layer 38 is formed by electoless planting. Next, another metal layer 40 is formed on the metal layer 38. The material of the metal layer 40 is, for example, Cu or an alloy thereof, and the metal layer 40 is formed by electoplating or electoless plating.

Referring to FIG. 3D, a photolithography and etching process is performed to pattern the metal layers 38, 40 so as to form patterned metal layers 38a, 40a which form a conductive line 42. The shape of the conductive line 42 depends on the requirements, and the shape can be rectangular or trapezoid in cross-section view.

In this embodiment, the metal layers 38, 40 are patterned by photolithography and etching process after the second metal layer 40 is formed. Actually, the metal layers 38, 40 can be patterned by other methods, and two examples are described in the following paragraphs.

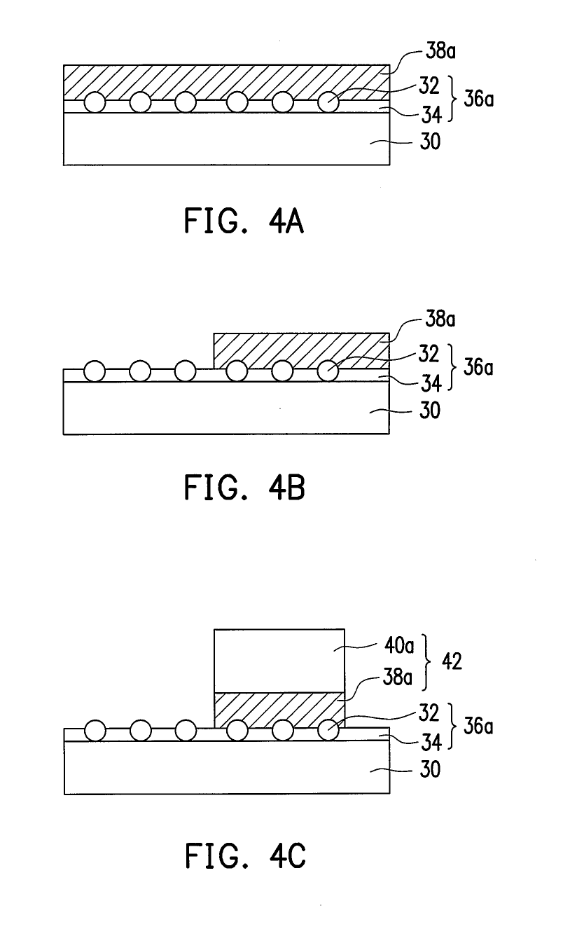

FIGS. 4A-4C are cross-sectional views showing a method of forming a metal line according to an embodiment of the present invention.

Referring to FIG. 4A, a catalytic adhesive layer 3 6a and a fist metal layer 38 are formed on an insulating substrate 30 by using the material and method described as above mentioned. Next, as shown in FIG. 4B, a photolithography and, etching process is performed to pattern the first metal layer 38 to form a patterned metal layer 38a. Then, referring to FIG. 4C, another metal layer 40a is formed on the metal layer 38a so as to form a conductive line 42. The material of the metal layer 40 is, for example, Cu or an alloy thereof, and the metal layer 40 can be formed by electoplating or electoless plating.

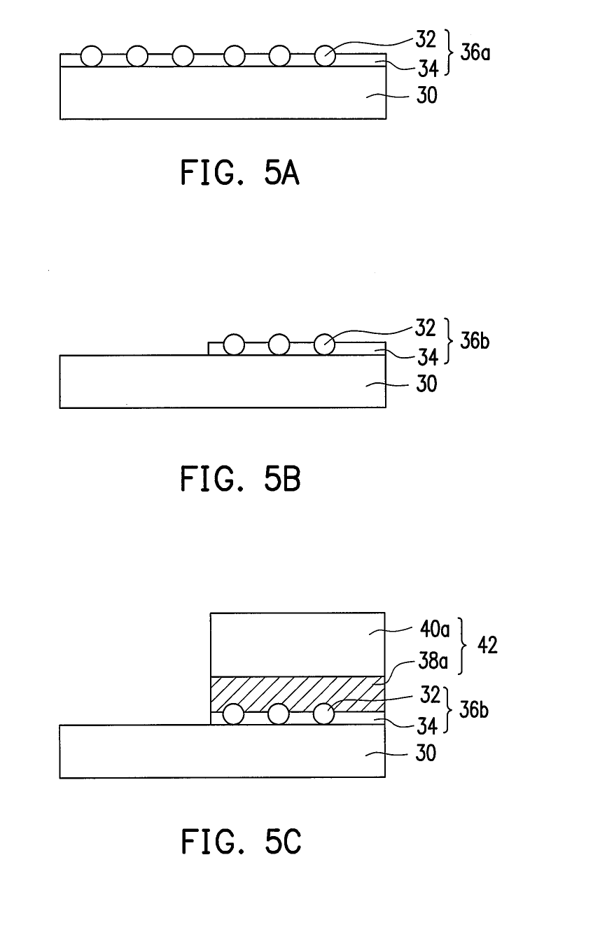

FIGS. 5A-5C are cross-sectional views showing a method of forming a metal line according to another embodiment of the present invention.

Referring to FIG. 5A, a catalytic adhesive layer 36a is formed on an insulating substrate 30 by using the material and method described as above mentioned. Next, as shown in FIG. 5B, a photolithography and etching process is performed to pattern the catalytic adhesive layer 36a so as to form a patterned catalytic adhesive layer 36b. Then, as shown in FIG. 5C, a metal layer 38a and a metal layer 40a are formed on the patterned catalytic adhesive layer 36b so as to form a conductive line 42. The material of the metal layer 38 is, for example, Cu, Ni, Co, W, Ag or an alloy thereof, and the metal layer 38 can be formed by electoless planting. The material of the metal layer 40a is, for example, Cu or an alloy thereof, and the metal layer 40 can be formed by electoplating or electoless plating.

For the foregoing, the method of forming the metal line of the present invention can form the catalytic adhesive layer on a single surface of the substrate, and therefore the metal film can be subsequently formed on the single surface of the substrate by using electoless plating.

In addition, in the method of forming the metal line of the present invention, the adhesion between the film and the glass substrate is increased through the catalytic adhesive layer formed on the single surface of the substrate, and thus the metal film can be formed by electoless plating without micro-roughing the glass substrate.

Moreover, in the method of forming the metal line of the present invention, the catalytic adhesive layer is not formed by immersing in a catalyst tank, and therefore the process is simple and the space for the tank is not needed.

The metal line is formed of two metal layers in the forgoing embodiment for illustration, however, it does not limit the present invention. The present invention can also form a metal line constituted of a single metal layer or two or more metal layers.

In addition, the method of forming the metal line of the present invention can be applied to fabricate metal lines of thin film transistor liquid crystal displays or plasma display panels. The method of fabricating a thin film transistor is described in the following paragraphs.

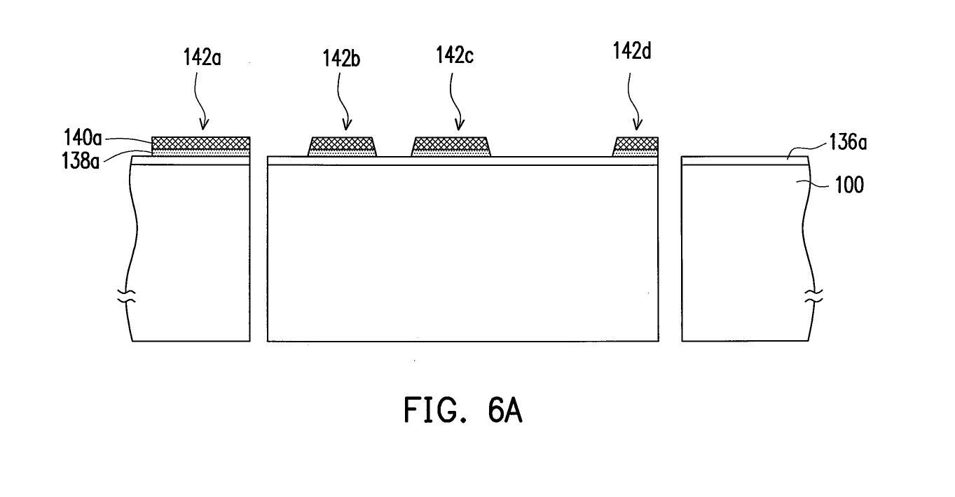

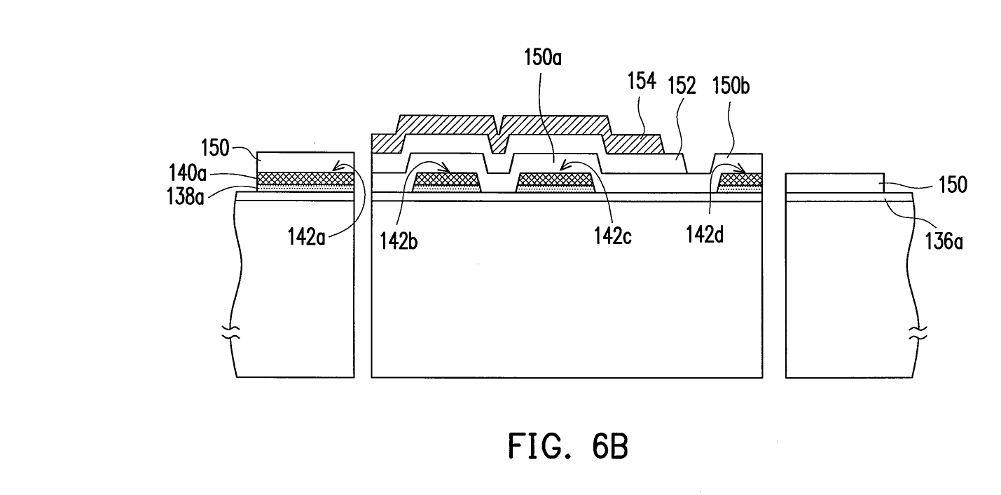

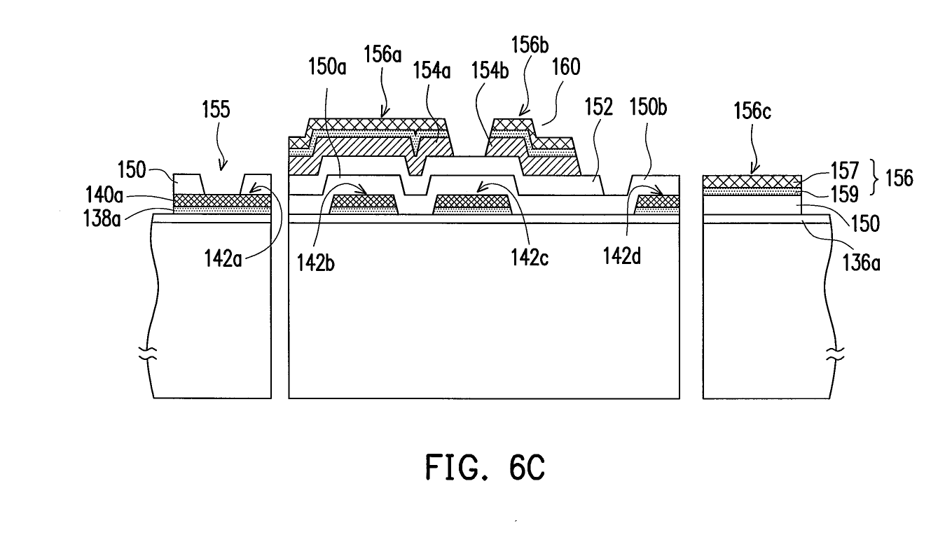

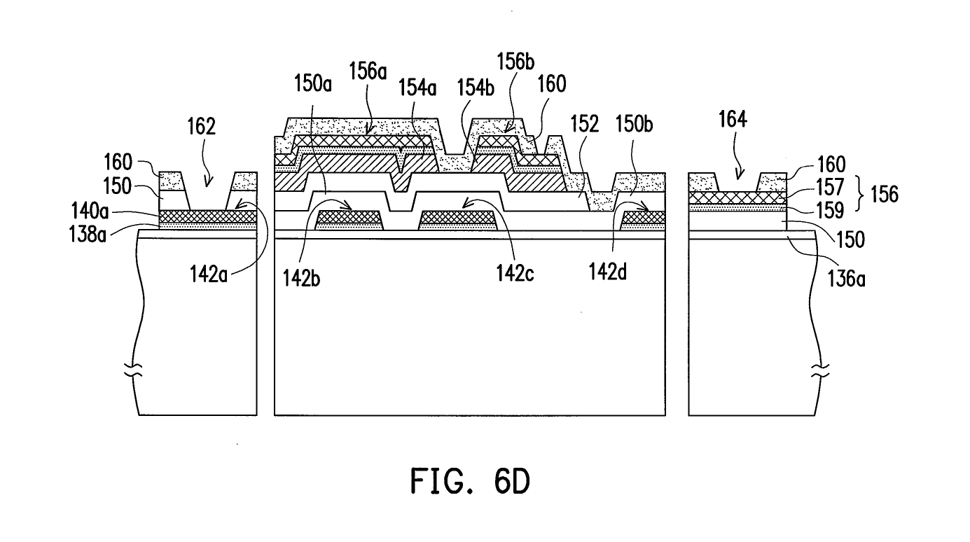

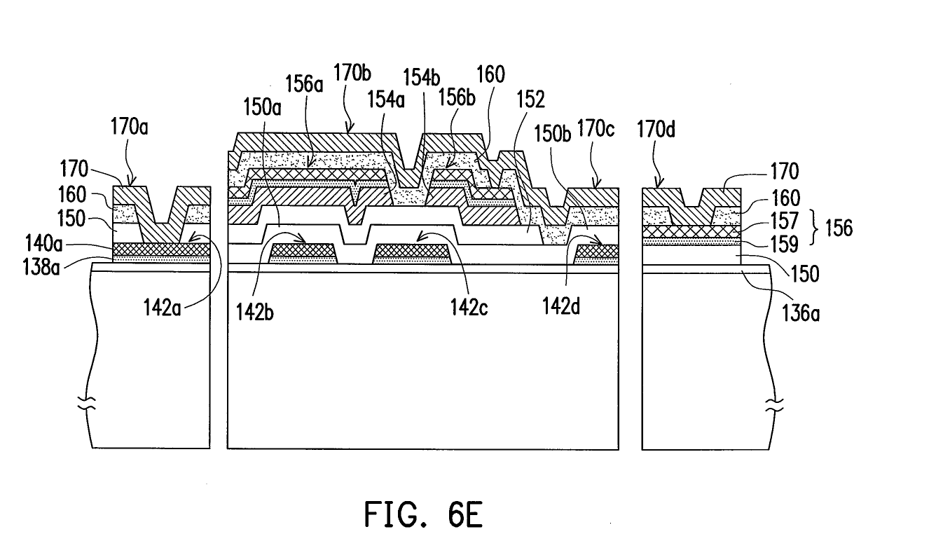

FIGS. 6A-6E are cross-sectional views illustrating the steps of fabricating a thin film transistor according to a embodiment of the present invention.

Referring to FIG. 6A, a catalytic adhesive layer 136a is formed on a substrate 100. Then, metal layers 138a, 140a are formed on the catalytic adhesive layer 136a so as to form a scan line pad 142a, a gate conductive layer of a first gate 142b, a gate conductive layer of a second gate 142c and a capacitor electode 142d. The catalytic adhesive layer 136a is formed by coating a mixture comprising an electoless plating catalyst, an organic polymer and a suitable organic solvent onto the substrate 100, and then a high temperature thermal process is performed to remove the organic solvent. The electoless plating catalyst comprises palladium (Pd), stannum (Sn) or a mixture thereof, and the electoless plating catalyst has an amount of 0.1-5% based on the total weight of the mixture. The organic polymer comprises acrylic-copolymer, polyimide, benzocyclobutene or polyarylene ether. The organic solvent is NMP, for example. The material of the metal layer 138a is, for example, Cu, Ni, Co, W, Ag or an alloy thereof, and the metal layer 138a can be formed by electoless planting. The material of the metal layer 140a is, for example, Cu or an alloy thereof, and the metal layer 140a can be formed by electoplating or electoless plating. The method of patterning the metal layers 138a, 140a can use the method as above mentioned.

Thereafter, referring to FIG. 6B, a dielectric layer 150 is formed over the substrate 100. The dielectric layer 150 covering the gate conductive layer of the first gate 142b and the gate conductive layer of the second gate 142c is so-called a gate dielectric layer 150a, and the dielectric layer 150 covering the electode 148 is so-called a storage capacitor dielectric layer 150b. The material of the dielectric layer 150 is, for example, SiNₓ, SiO₂ or Ta₂O₅. The method of forming the dielectric layer 150 includes, for example, the chemical vapor deposition process. Next, a patterned channel layer 152 and a patterned ohmic contact layer 154 are formed on the dielectric layer 150. The channel layer 152 is fabricated using amorphous silicon and the ohmic contact layer 154 is fabricated using n+doped amorphous silicon, for example.

Thereafter, referring to FIG. 6C, a patterned metal layer 156 is formed over the substrate 100, and the ohmic contact layer 154 underneath is patterned again to form the ohmic contact layers 154a, 154b separated from each other, and the dielectric layer 150 over the scan line pad 142a is patterned again to form an opening 155. The patterned metal layer 156 is as a source 156a, a drain 156b and a data line pad 156c. The patterned metal layer 156 is constituted of a metal layer 157, such as copper or aluminum layer, and a metal layer 159 underneath, such as molybdenum or alloy.

Next, Referring to FIG. 6D, a passivation layer 160 is formed over the substrate 100, and then the passivation layer 160 is patterned to form openings 162, 164.

Thereafter, referring to FIG. 6E, a conductive layer 170 is formed over the substrate 100. The conductive layer 170 covering the scan line pad 142a is so-called a contact portion 170a; the conductive layer 170 covering the gate conductive layers 142b, 142c is a portion of a pixel electode 170b; the conductive layer 170 covering the electode 142b is another electode 170c of the storage capacitor; and the conductive layer 170 covering the data line pad 156c is so-called a contact portion 170d. The material of the conductive layer 170 is, for example, indium tin oxide (ITO).

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A method of fabricating a metal line by a wet process, comprising:
forming a catalytic adhesive layer on an insulating substrate;
depositing a first metal layer with an electoless plating process;
depositing a second metal layer with an electoless plating process or an electoplating process; and
patterning at least one of the second metal layer, the first metal layer and the catalytic adhesive layer.

2. The method of claim 1, wherein the catalytic adhesive layer comprises an electoless plating catalyst and an organic polymer which used as an adhesive, and the electoless plating catalyst and the organic polymer are formed on the substrate at the same time.

3. The method of claim 2, wherein the method for forming the catalytic adhesive layer comprises:
preparing a mixture comprising the electoless plating catalyst and the organic polymer; and
coating the mixture onto-the insulating substrate and performing a baking process to form the catalytic adhesive layer.

4. The method of claim 3, wherein the organic polymer comprises acrylic-copolymer, polyimide, benzocyclobutene or polyarylene ether.

5. The method of claim 3, wherein the electoless plating catalyst comprises palladium (Pd), stannum (Sn) or a mixture thereof.

6. The method of claim 3, wherein the method of coating the mixture onto the insulating substrate comprises spin coating, slit coating or printing.

7. The method of claim 1, wherein the step of patterning at least one of the second metal layer, the first metal layer and the catalytic adhesive layer is performed after forming the first and second metal layers so as to pattern the second and first metal layers.

8. The method of claim 1, wherein the step of patterning at least one of the second metal layer, the first metal layer and the catalytic adhesive layer is performed after forming the first metal layer and before forming the second metal layer so as to pattern the first metal layer, such that the second metal layer is directly formed on the patterned first metal layer.

9. The method of claim 1, wherein the step of patterning at least one of the second metal layer, the first metal layer and the catalytic adhesive layer is performed after forming the catalytic adhesive layer and before forming the first metal layer so as to pattern the catalytic adhesive layer, such that the first and second metal layers are sequentially formed on the patterned catalytic adhesive layer.

10. The method of claim 1, wherein the material of the first metal layer comprises Cu, Ni, Co, W, Ag or an alloy thereof.

11. The method of claim 1, wherein the material of the second metal layer comprises Cu or an alloy thereof.

12. The method of claim 1, wherein the material of the insulating substrate comprises glass.

13. A method of forming a metal line of a thin film transistor liquid crystal display or a plasma display panel according to the method of fabricating the metal line by wet process of claim 1.
